(19) United States
(12) Patent Application Publication
(10) Pub. No.: US 2009/0276338 A1
(43) Pub. Date: Nov. 5, 2009

(54) SYSTEM AND METHOD FOR SHARING INFORMATION AND CAUSING AN ACTION BASED ON THAT INFORMATION

(75) Inventors: Ute MASERMANN, Koblenz (DE); Michael WELLENBECK, Offenbach (DE)

Correspondence Address: NIXON PEABODY, LLP, 401 9TH STREET, NW, SUITE 900, WASHINGTON, DC, 20004-2128, US

(73) Assignee: DEUTSCHE BORSE AG, Frankfurt/Main (DE)

(21) Appl. No.: 12/500,762

(22) Filed: Jul. 10, 2009

Related U.S. Application Data
(62) Division of application No. 11/503,403, filed on Aug. 14, 2006.

(51) Int. Cl. G06Q 10/00; G01S 5/00; H04Q 5/22; G06K 7/10

(52) U.S. Cl. 705/28; 342/357.07; 340/10.1; 235/462.01; 235/487

(57) ABSTRACT

A physical objects tracking system and a method for sharing information about objects and causing an action based on that information is provided. Short range communication networks collect data which identify physical objects and attributes associated with the objects. Long range communication networks provide both central data processing equipment, which is hosted by a trusted third party, for aggregating and storing the collected data and user terminals for enabling authorized user to access the data processing equipment and to evaluate the aggregated data. The authorized user is enabled to define a business rule, which specify a matching condition and an action. The matching condition is matched against the aggregated data and if it is determined that the matching condition is fulfilled, the action is executed. Embodiments implementing an auto-ID clearing and risk management process and a secondary market process are introduced.

### BACKGROUND OF THE INVENTION

1. Field of the Invention

The present invention relates to tracking physical objects, and more particular to sharing information about the tracked objects.

2. Description of the Related Art

In today's economy, the transaction of physical objects from a producer to a retailer is strongly connected with the flow of information and cash. Referring to FIG. 1a, a producer 102 delivers its objects to a retailer 106 via a distribution hub or logistic provider 104. Besides the physical movement of the objects 100, there is also a distribution of digitized information 110 as well as the flow of cash and documents 120. The producer 102 may, for example, issue an advance shipping notice 122 as soon as the objects are picked up by the logistic provider 104. Together with that notice 122, the producer 102 or the logistic provider 104 may issue a bill of lading 124 to the retailer 106. By receiving the objects, the retailer 106 confirms the receiving of the objects with a receiving notice 126 whereupon the producer 102 sends an invoice 128 to the retailer 106. The business transaction is eventually completed with the payment 130.

Today auto-ID (automated identification) technologies are applied in many processes in which physical objects have to be stored, transported, legally transferred or maintained in any business area or country of the world.

For example, auto-ID technologies are applied to allow users to follow the geographical movements of objects, which might be assets, goods, blood or pathology samples (track and trace process). Generally, an object is defined and merged with a signalling device. The signalling device will either periodically, on-demand or when moved through certain antenna/reader fields automatically identify the relevant object.

In today's economy, such auto-ID processes are implemented between parties with a 1:1 or 1:n or even a m:n relationship in existing enterprise resource planning or agent based systems. Mutual agreements between those parties exist which define who is allowed to receive what information. In the current environment those complex relationships are broken down to 1:1 or 1:n relationships for practical reasons. Thereby all parties interacting in the complex process have only access to a limited data pool.

FIG. 1b illustrates for the track and trace example an m:n business relationship. Suppliers 151-154 ship goods to distribution centers 171-173 engaging different carriers 160A1-160A4, 161B1, 161B2, 162C1-162C4. From the distribution centers 171-173 the goods are shipped to different retailers 181 and 182, again using carriers 160A5, 161B3, 161B4, 162C5-162C7. In this case many parties participate in a supply chain process and are interested in analyzing data which is generated when passing several auto-ID readers. On the other hand, one supplier delivers to many retailers, one retailer gets many goods from many suppliers and furthermore, one logistic provider handles routes between different suppliers/distribution centers/retailers. These many-to-many relationships have to be handled by the software used by the different parties causing a considerable amount of effort and costs.

### SUMMARY OF THE INVENTION

According to one aspect of the invention, a physical objects tracking system includes: (a) at least one short range communication network configured to collect data identifying physical objects and attributes associated with said objects; and (b) at least one long range communication network. The at least one long range communication network comprises: (b1) central data processing equipment hosted by a trusted third party, said central data processing equipment being configured to aggregate and store data collected by the at least one short range communication network; and (b2) at least one user terminal configured to enable an authorized user to access the data processing equipment hosted by the trusted third party to evaluate the aggregated and stored data.

According to another aspect of the invention, a trusted third party data processing apparatus includes: (a) a network interface module configured to securely couple to a plurality of networks of different types and receive data in a plurality of different data formats, said data describing properties of physical items; (b) a data harmonizer configured to convert the received data into a pre-defined data format; (c) a data accumulation module configured to extract said properties from the converted data; (d) a central repository configured to store the extracted properties; (e) a task handling module configured to store, manage and execute tasks concerning the physical items and their properties; and (f) an access handling module configured to grant authorized remote entities access to the task handling module and the central repository.

According to yet another aspect of the invention, a method for sharing information about objects and causing an action based on said information includes the acts of: (a) accepting a definition of a business rule remotely issued by an authorized user, the business rule specifying a matching condition and an action, the matching condition indicating in which case the action is to be executed; (b) registering relevant objects for the business rule; (c) identifying at least one distant source, said distant source automatically collecting attributes of the relevant objects; (d) receiving the collected attributes of the relevant objects from the at least one distant source; (e) checking the collected attributes of the relevant objects against the defined matching condition; and (f) if it is determined that the matching condition is fulfilled for the business rule, executing the action.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1a illustrates an exemplary transaction of physical objects from a producer to a retailer;

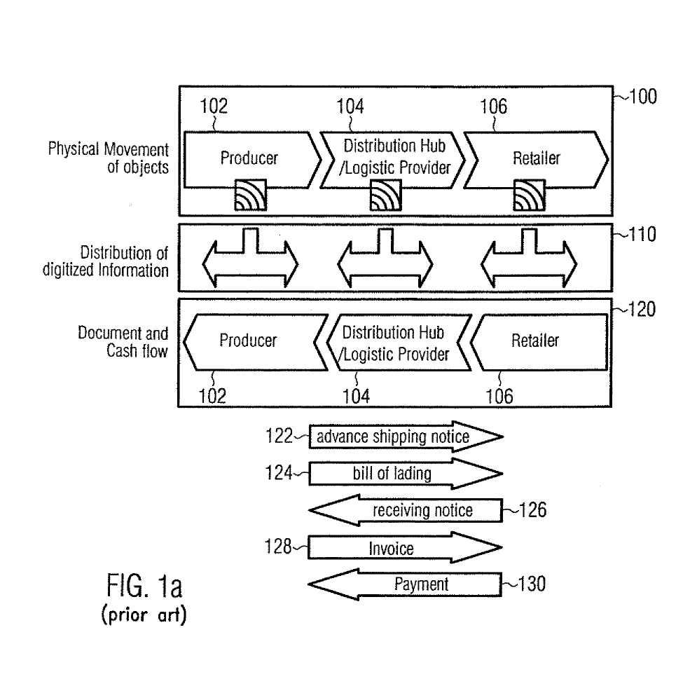

FIG. 1b illustrates an exemplary m:n business relationship;

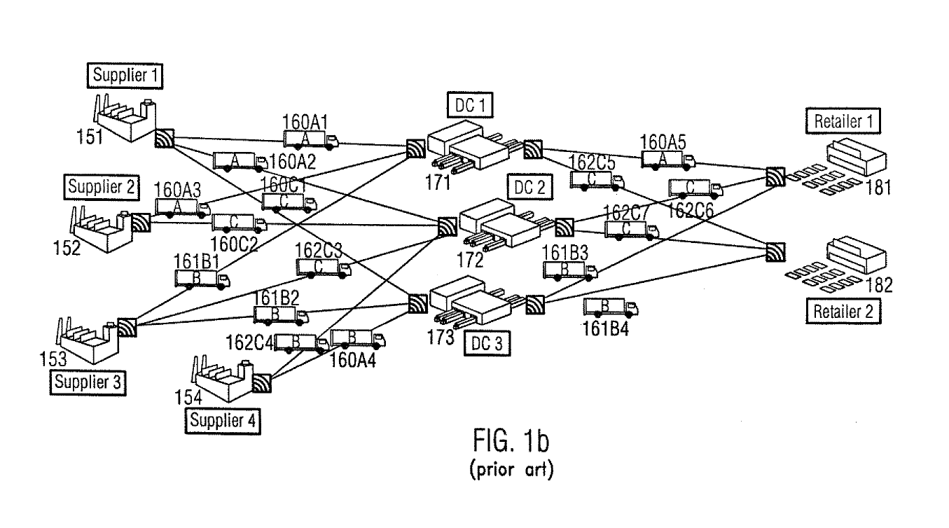

FIG. 2a illustrates an exemplary arrangement for a Clearing House as central entity managing a transaction of physical objects from a producer to a retailer;

FIG. 2b illustrates an exemplary arrangement for a Clearing House as central entity managing an m:n business relationship;

FIG. 3a illustrates an exemplary architecture for an auto-ID Clearing House system managing an m:n relationship;

FIG. 3b illustrates an exemplary architecture for an auto-ID Clearing House system managing an m:n relationship;

FIG. 4 illustrates an exemplary architecture for an auto-ID system;

FIG. 5 illustrates an exemplary architecture for central data processing equipment of an auto-ID Clearing House;

FIG. 6 shows an exemplary process for sharing information about objects and causing an action based on the information;

FIG. 7 shows an exemplary process for identifying relevant auto-ID systems and accumulating relevant data;

FIG. 8 shows an exemplary process for identifying relevant auto-ID systems and accumulating relevant characteristics:

FIG. 9 shows an exemplary process for identifying relevant auto-ID systems;

FIG. 10 shows an exemplary auto-ID Clearing House process;

FIG. 11 shows an exemplary entity relationship diagram for a data base used in an auto-ID Clearing House process;

FIG. 12 illustrates an exemplary global object life cycle and supply chain;

FIG. 13 shows an exemplary auto-ID clearing and risk management process; and

FIG. 14 shows an exemplary secondary market process based on an auto-ID Clearing House.

### DETAILED DESCRIPTION OF THE INVENTION

The illustrative embodiments of the present invention will be described with reference to the figure drawings wherein like elements and structures are indicated by like reference numbers.

Clearing Houses are common in financial markets. They allow for post-trade anonymity, mitigation of (counter party) risk as well as automated straight through processing until a financial settlement is achieved. The technical progress in auto-ID technology together with the present invention will in the future allow the application of many services currently only available for financial products to physical objects/goods.

In more general terms a Clearing House aims at collecting valuable information in a specific field and at making that information available to people and groups working in that field. As a central access point, a Clearing House serves the needs of users of a specific body of knowledge. One of its functions is to prevent the duplication of effort by those users by identifying, describing and evaluating information relevant to their knowledge area. Hence, in some of its tasks, a Clearing House is similar to a library, repository, or a warehouse in that it receives, organizes and disseminates information. In addition the Clearing House can ensure anonymity or the routing of information to eligible parties, the matching of information originating from different sources and the confirmation of the matching to the relevant parties, the decomposition and management of risk associated with a business transaction, the final financial settlement of the relevant transactions and be used as basis for a secondary market for any kind of object.

It is important to note that neither a portal nor a closed loop linkage of e.g. ERP (Enterprise Resource Planning) systems between a limited number of parties with mutual contracts is a Clearing House. A portal can be characterized as a collection of diverse resources that are produced entirely by or managed by the host organization. A closed loop linkage of e.g. ERP systems misses the character of being a central repository as well as information distribution and confirmation hub.

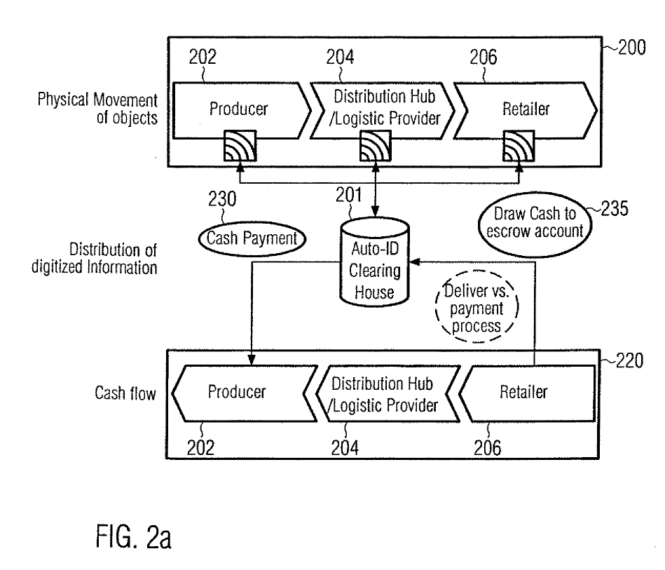

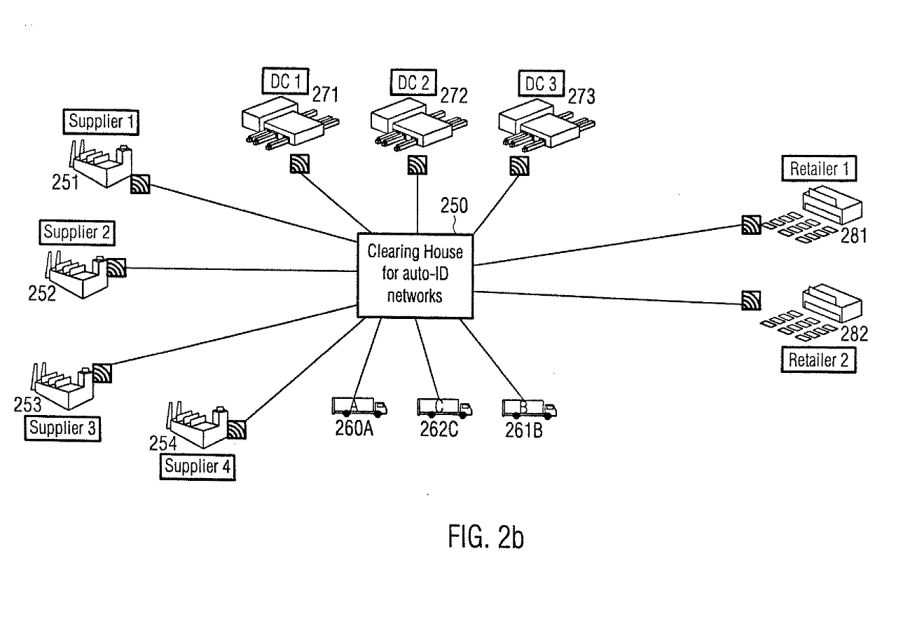

Referring now to FIG. 2a, according to one aspect of the invention a Clearing House 201 may track and potentially manage the movement of physical objects 200 which take place in a business transaction and based on the auto-ID Information received manage both the redistribution of this information as well as the cash flow 220 associated with that physical movement of objects 200. Both the distribution of digitized information and the payment events 230, 235 may be managed straight-through by the Clearing House 201 triggered by relevant auto-ID technology based events.

Referring now to FIG. 2b, embodiments of the current invention offer the facility not to implement each of the m:n relationship directly as a peer to peer connection but to deal as a central clearing party 250. Then all suppliers 251-254 have to send their data only to one party 250 and each retailer 281 and 282 (or any other party 260A, 261B, 262C, 271, 272, 273 which receives data or sends data) gets the data from only one party 250.

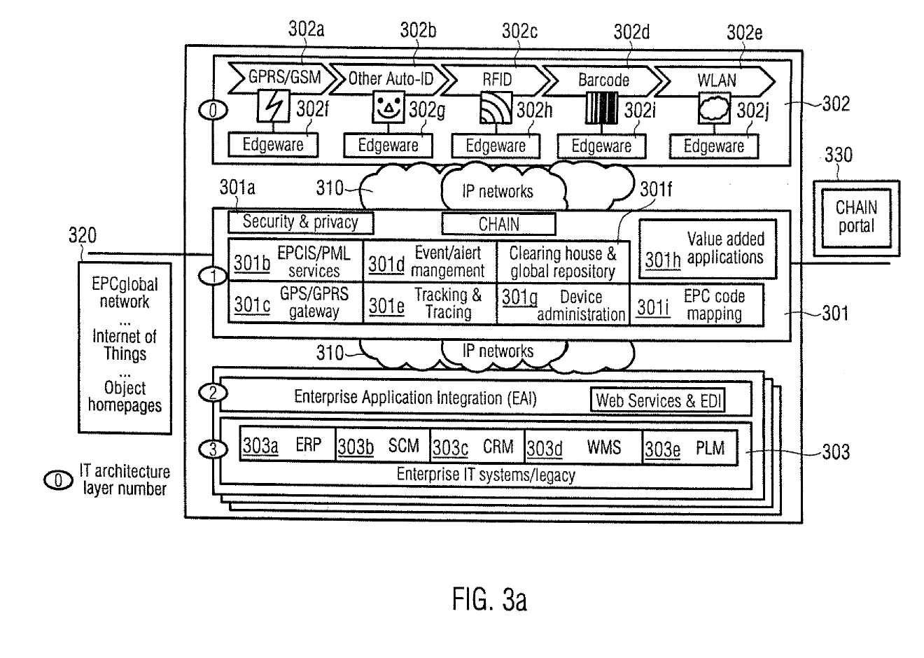

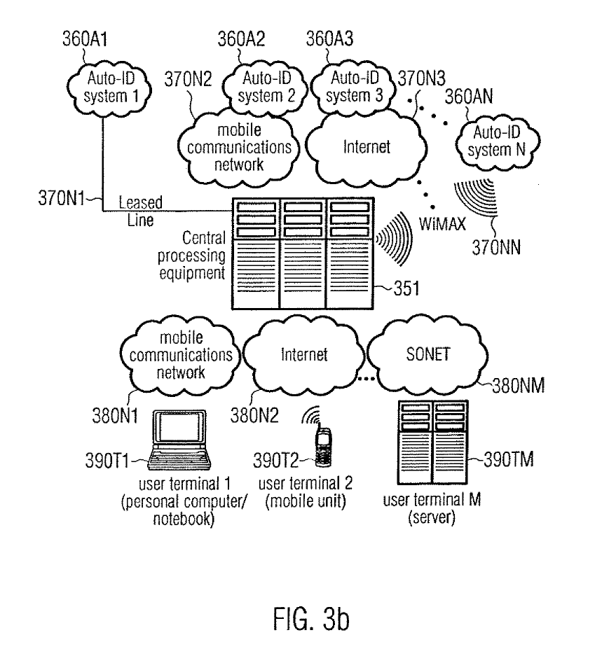

With reference to FIG. 3a, the Clearing House for Auto-ID Networks (CHAIN) 250, 301 may provide several modules 301a-301i. Such modules include, but are not limited to, a security and privacy module 301a, a module which provides Electronic Product Code Information Services (EPCIS) or Physical Mark up Language (PML) services 301b, a Global Positioning Service (GPS) and General Packet Radio Services (GPRS) gateway module 301c, an event or alert management module 301d, a tracking and tracing module 301e, a Clearing House and global repository module 301f, a device administration module 301g, a value added applications module 301h and an Electronic Product Code (EPC) mapping module 301f. The Clearing House for auto-ID networks 250, 301 may also provide a connectivity module to the EPC global network, the so called “internet of things” and underlying object homepages summarized in box 320. A portal 330 enables access to the Clearing House for auto-ID networks 301. The Clearing House for auto-ID networks 301 is connected via a plurality of IP networks 310 on the one hand to a plurality of auto-ID systems 302 and to a plurality of enterprise IT systems 303 via an Enterprise Application Integration (EAI) layer. The plurality of auto-ID systems may include, but is not limited to GPRS/GSM (Global System for Mobile Communications) systems 302a, RFID (Radio Frequency ID) systems 302c, barcode systems 302d, WLAN (Wireless Local Area Network) systems 302e, and other auto-ID systems 302e. Each such system 302a-302e may be connected to an Edgeware server 302f-302j. On the other hand, the enterprise IT systems 303 may include, but are not limited to, Enterprise Resource Planning systems (ERP) 303a, Supply Chain Management (SCM) modules 303b, Customer Relationship Management (CRM) modules 303c, Warehouse Management System (WMS) modules 303d and Product Life cycle Management modules (PLM) 303e and other relevant Enterprise IT systems or legacy systems.

With reference to FIG. 3b, illustrating a further embodiment of the invention, central computing equipment 351 (alike or different to devices 201, 250, 301), which may be hosted in some examples by a trusted third party, may handle the processing of auto-ID signals and other electronic messages like SMS, MMS, e-mail, instant messages or, in general, a stream of data packets. On the one hand, a plurality of auto-ID systems 360A1-360AN may locally collect attributes or characteristics of physical objects and send that information about the objects via a plurality of network types 370N1-370NN to the central data processing equipment 351. On the other hand, remote entities may be interested in such information collected by the auto-ID systems 360A1-360AN.

The remote entities may for example enter their request into any suitable user terminal 390T1-390TM which communicates it via a plurality of network types 380N1-380NM to the central computing equipment 351. In some embodiments, the users may also be informed automatically about relevant events according to pre-defined (business) rules via such user terminals 390T1-390TM. In case the equipment 351 is hosted by a trusted third party, the trusted third party may guarantee in turn a reliable processing of the requests and the auto-ID information and arranges an exchange of data on a secure basis as well as, if desired, on an anonymous basis.

Regarding the auto-ID systems 360A1-360AN in more detail, such systems may be, but are not limited to, one or two dimensional barcode systems, RFID (Radio Frequency ID) systems, biometric systems, systems based on magnetic stripes, OCR (Optical Character Recognition) systems, smart card systems, voice recognition systems or any system which automatically collects information about objects. The attributes or characteristics of objects may also have been entered manually by a human being into a system or data base.

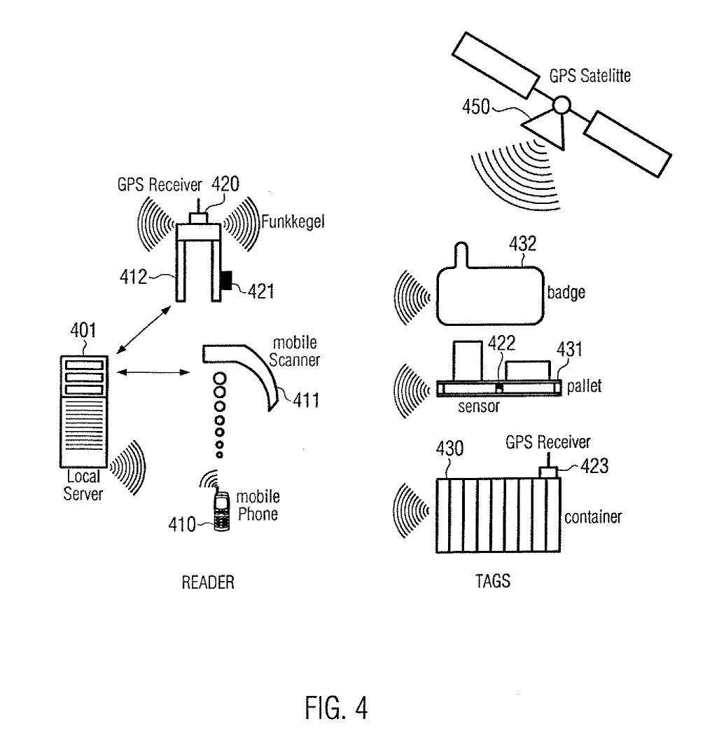

Referring now to FIG. 4, an exemplary auto-ID system (like that of 360A1-360AN) may have a local server 401 which locally accumulates and manages data identifying physical objects and their characteristics or attributes. The computing device 401 may also be coupled to an LAN (Local Area Network), an MAN (Metropolitan Area Network) or a WAN (Wide Area Network) via a plurality of technologies. The computing device 401 may also handle remote access to the auto-ID system or provide remote entities with data.

The computing device 401 may receive the data, which comprise the information about physical objects, from one or more readers 410-412. In some embodiments the reader may be incorporated in a mobile computing device 410 and 411 like a mobile phone, a PDA (Personal Digital Assistant), or a laptop which may transfer the data to the local server 401 via a wireless connection like Bluetooth, Infrared connection, WLAN (Wireless LAN), GSM (Global System for Mobile Communication), GPRS (General Packet Radio Service), UMTS (Universal Mobile Telecommunication System), HSDPA (High Speed Downlink Packet Access) or CDMA2000 (Code Division Multiple Access) or via a wired solution. In another embodiment, the data may be stored on a portable media device like flash memory cards, USB (Universal Serial Bus) sticks, magnetical or optical memory devices and the data may periodically be transferred to the server 401 by plugging the portable media device into the server 401.

The reader itself may be, for example, an RFID-reader, an optical scanner or whatever reader the auto-ID system 360A1-360AN may require and may be stationary or mobile. In one example the reader 410-412 may even be equipped with a GPS (Global Positioning System) receiver 420, which allows an exact localization of the reader. For some embodiments it might be desirable to be aware of physical conditions of the environment of the reader. If, for example, the reader is to collect attributes or characteristics of perishables (for example in a cold warehouse), a user might be interested in the current temperature or humidity of the environment of the reader or if the reader is for example located at a brewery, a user might like to be notified if the oxygen concentration drops below a certain threshold. Safety considerations may further suggest measuring the hydrogen concentration, the barometric pressure or the radioactivity of the environment of the reader. These physical properties may be measured and provided to the reader or directly to the server 401 by a sensor 421 which might be attached to the reader or separately located in the same environment. In yet another embodiment the security of the environment of the reader might be a great issue. Therefore, the reader might be provided for example with one or more of a motion detector, a video camera or a microphone in order to observe valuable objects.

The characteristics or attributes of an object may be stored on a tag which may be directly attached to the corresponding object. In some embodiments the tag may be mounted on a badge 432, a pallet 431 or a container 432. The reader is configured to read out the information stored on the tags and provide it to the computing device 401. Like the reader, the object or the tag might be equipped in addition with a GPS receiver 423 or with a sensor 422 measuring physical properties of the environment of the object or physical properties inside the object. In these embodiments, the reader is further configured to read out the sensor and the GPS receiver.

Referring back to FIG. 3b, the auto-ID systems 360A1-360AN may communicate the information identifying physical objects and attributes or characteristics associated with that objects to central processing equipment 351 via a plurality of network technologies in a plurality of data formats. Such technologies include, but are not limited to, leased direct lines 370N1, mobile communication networks 370N2, the internet 370N3, WiMAX (Worldwide Interoperability for Microwave Access) 370NN or any other suitable network type.

As already mentioned, there may be a plurality of remote entities which are interested in the information characterizing physical objects collected by the auto-ID systems 360A1-360AN. To avoid redundant effort, these remote entities may indicate their interest in information about certain objects by addressing their request to a central entity 351. These requests may be entered into any suitable terminal device like a mobile phone, a PDA or any stationary or portable computing device and may be transferred via any suitable network technology 380N1-380NM to the central entity 351. In some embodiments the remote entity may employ an auto-ID system by itself and therefore may use the same infrastructure as the respective auto-ID system.

In some embodiments, at least some remote entities may not only be interested in information about objects but also in executing some tasks concerning the objects. Such tasks could be for example buying an object with certain characteristics from another remote entity, physically transferring an object from one location to another by employing transport capabilities offered by yet another remote entity or checking periodically some crucial characteristics of objects like current temperature, current location, current lading status, etc. More such examples will be described below in more detail.

The central entity 351 may handle the processing of the auto-ID data and the requests or tasks remotely issued, and thereby implements m:n relationships between the remote entities.

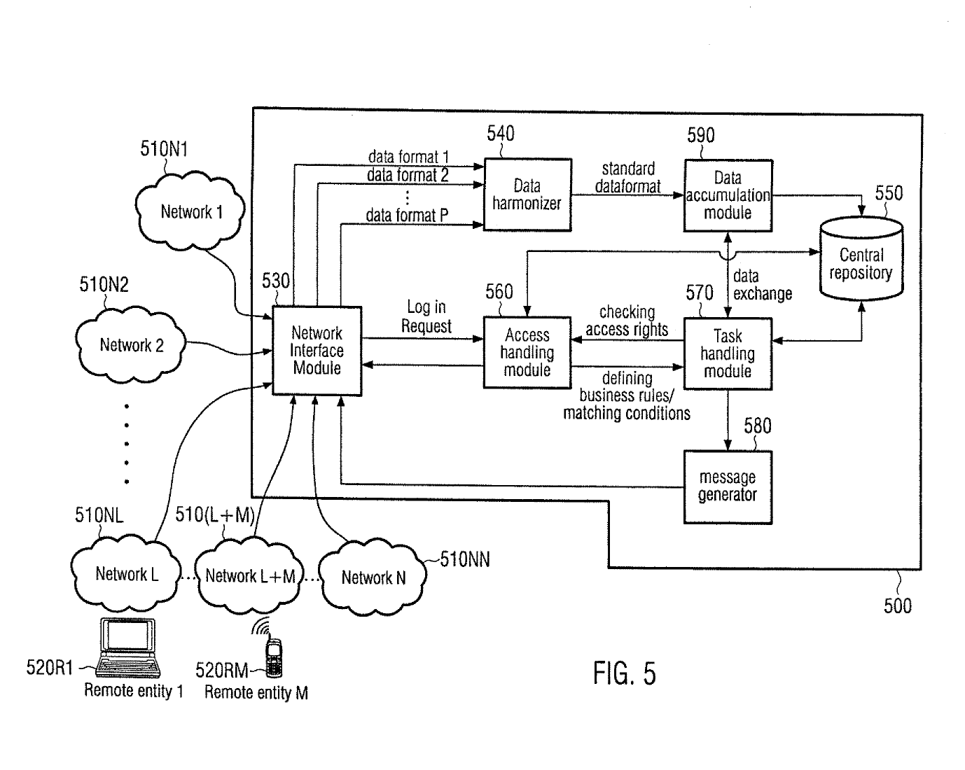

FIG. 5 illustrates an exemplary architecture of central data processing equipment 500 (alike or different to devices 201, 250, 301, 351). A network interface module 530 is configured to securely couple the equipment 500 to a plurality of network types 510N1-510NN. Such network types may include, but are not limited to the Internet, POTS (Plain Old Telephone Service), ISDN (Integrated Services Digital Network), SONET (Synchronous Optical Network), ATM (Asynchronous Transfer Mode) network, GSM (Global System for Mobile Communication), GPRS (General Packet Radio Service), UMTS (Universal Mobile Telecommunication System), HSDPA (High Speed Downlink Packet Access), CDMA2000 (Code Division Multiple Access) or WiMAX (Worldwide Interoperability for Microwave Access). In one embodiment one network interface module may connect the central data processing equipment 500 to both the plurality of auto-ID systems like 302a-302e and/or 360A1-360AN and the plurality of user terminals 303 and/or 390T1-390™, in another embodiment one network module may couple the remote entities 520R1-520RM to the data processing apparatus 500 and another network interface module may couple to the auto-ID sources 302a-302e and/or 360A1-360AN. In the example of FIG. 5, the network interface module 530 may split the incoming data stream into a first data stream containing the information about objects (collected by the auto-ID sources 302a-302e and/or 360A1-360AN) and into a second data stream containing the requests/tasks issued by the remote entities 520R1-520RM.

Considering first the exemplary data flow of the data stream containing the auto-ID data, this stream may be directed towards a data harmonizer 540. Since a plurality of different auto-ID systems like 302a-302e, 360A1-360AN may be coupled to the central data processing equipment 500, the data from the auto-ID systems 302a-302e and/or 360A1-360AN may have been transferred in a plurality of different data formats to the equipment 500. The data harmonizer 540 may therefore analyze the data stream and may convert the data into a sole pre-defined data format. This data may then be passed to a data accumulation module 590 for further processing or directly stored in a central repository 550.

In some embodiments the data accumulation module 590 may analyze the data in order to extract characteristics of objects or attributes associated with those objects and pass those characteristics or attributes to the central repository 550 for centrally storing the extracted data in a pre-defined data format.

In some embodiments the central data processing equipment 500 may be hosted by a trusted third party. To guarantee data privacy and data security, the requests of the remote entities 520R1-520RM may be directed to an access handling module 560 which manages the remote access to the computing equipment 500. In some embodiments a registration process may be performed prior to the first log in of a remote entity. Thus, the access handling module 560 may ensure a flexible and highly credible authentication and authorization of the remote users 520R1-520RM.

In some embodiments, the data describing the objects may contain for example information about the owners of the objects. In these embodiments, data privacy and data security could be guaranteed by restricting access of every record in the central repository to only the owner of the object related to this record, to one or more other users (who may be combined to access groups) or to the public. These access rights may be assigned explicitly by the owner of the object or automatically by the trusted third party. Additionally, only parts of a record may be made available for access by other users than the owner of the object. Table 1 gives an example of assigned access rights to records of the central repository 550 handled by the access handling module 560.

Every record has an owner who assigns access rights. In case of public access, all users of the Clearing House 201, 250, 301, 351, 500 are allowed to access this record. The records 4-6 show an example for single and group access, respectively. Record 2 shows how only individual attributes may be accessed: the record access is restricted and every attribute has its own access rights.

As a result of the granularity, the assignment of access rights may become a complex and tedious task, so in one example default access rights for a record are set as soon as the respective record is stored in the central repository 550. In some embodiments those access rights may be derived from bilateral agreements between different users/remote entities 520R1-520RM of the trusted third party's computing equipment 500, e.g. the owner of a consumer good and his logistic carrier.

In some embodiments the remote entities/users 520R1-520RM may issue tasks concerning physical objects or attributes associated with the physical objects. Those tasks may be handled by a task handling module 570. The task handling module 570 may store, manage and execute operations according to (business) rules remotely defined by users 520R1-520RM or automatically generated by the data processing equipment 500. In some embodiments a remote entity may indicate to the access handling module 560 that she/he wants to create a new task concerning a physical object whose attributes/characteristics are stored in the central data base 550. In one embodiment the access handling module 560 may firstly verify whether the respective user is authorized to access the respective records in the central data base 550 and then pass the task to the task handling module 570. In another embodiment, the access handling module 560 may pass the task directly to the task handling module 570, which in turn reconnects to the access handling module 560 as soon as the task is to be executed in order to check whether the user is authorized to issue the task. In some embodiments, the access handling module 560 may consult the owner of an object whether she/he wants to extend certain access rights in order to enable another user to perform a task concerning the respective objects or attributes associated with that object.

Those tasks may be formulated as (business) rules. Each rule may comprise a matching condition which may specify in which case a certain action is to be executed. The matching condition may be matched against the records of the central repository 550. In another embodiment the data accumulation module 590 may pass the characteristics or attributes of certain objects directly to the task handling module 570, which in turn matches the matching condition against those characteristics. The rule may further identify users which are relevant for the particular rule. Relevant users may for example be business associates or users registered for the rule. In some embodiments the matching condition may be intentionally left blank by the entity which defines the rule, or the central processing equipment 500 may define some rules with a fixed action and a variable matching condition. The entity which defines the rule may for example authorize a group of users to fill in the matching condition for a particular rule. In another example the trusted third party may generate a rule comprising an action of returning a list of attributes of objects with characteristics fulfilling the matching condition. In yet another example a remote entity could define a matching condition like “object X send via Carrier C by producer P reaches premises of distributor D” and the system would for example trigger an automatic payment from distributor D to producer B as well as a payment from producer P to Carrier C. In addition the system would trigger the generation of underlying electronic documents and would distribute them via the network 510N1-510NL to the relevant Legacy Systems 303 of the relevant involved parties. More examples of possible rules will be given in detail below.

In some embodiments the data processing apparatus 500 may be equipped with a message generator 580. The message generator 580 may generate messages to users associated with a rule as soon as a matching condition is fulfilled or as soon as characteristics of an object are recorded in the central data base 550 or passed to the task handling module 570 which fulfil the matching condition.

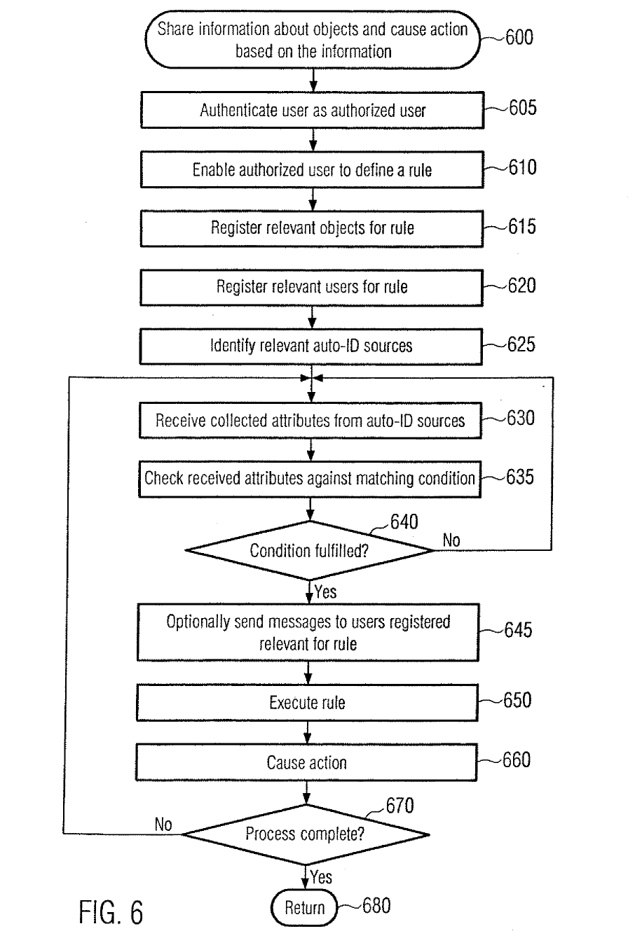

FIG. 6 shows an exemplary process 600, which may be established in central data processing equipment like 201, 250, 301, 351, 500, for sharing information about objects and causing an action based on that information. A user/remote entity sends a request to the central data processing equipment 500. Such a request may be access to the central data base 550 or defining a task/rule to be performed by the task handling module 570. In case the central processing apparatus 500 is hosted by a trusted third party, the remote entity may be authenticated by the access handling module 560 as authorized user for that particular request at act 605.

In another embodiment, the access handling module 560 may determine whether the user may define a task or whether he/she wants to access the central repository 550. If it is determined in that particular embodiment that the remote entity wants to issue a task, the access handling module 560 may pass the definition of the task/rule to the task handling module 570 with an annotation of not executing the task without consulting the access handling module 560. In that embodiment, a user is enabled to define a task without being authorized to issue that task at that point in time.

Returning to FIG. 6, the authenticated user is enabled at act 610 to define a task. Such a task may be a rule or in particular a business rule. The user may for example be asked to enter a matching condition and an action to be performed if the matching condition is fulfilled. A matching condition could for example be one or more characteristics of an object. An action may for example be a business event like buying an object, physically transferring an object or booking lading capacity. In some embodiments the user may enter only an action or a matching condition.

At act 615 either the authorized user or the trusted third party may register relevant objects for the rule. On this, the user may, for example, enter a list of objects she/he considers as relevant. For each object on that list, the user may provide a property or properties clearly identifying the respective object. In another example the user may search the data base 550 and mark the objects she/he wants to be registered for the rule at act 615. In that example the central computing system 500 may assign an identifying property to each registered object for that rule. In other examples, the user specifies a particular characteristic (i.e. temperature, pressure, geographical location) or property an object should have. The central data processing system 500 may then automatically prepare a list of relevant objects. To this, the processing apparatus 500 may search the central repository 550 for attributes matching the identifying property and register the respective object as relevant for that rule.

In some embodiments the authorized user is prompted to issue a list of relevant users for the rule at act 620. In addition the trusted third party's computing equipment 500 may search its data base 550 for users associated with relevant objects and annotate the respective users as relevant for the rule. At act 625, relevant auto-ID sources are identified.

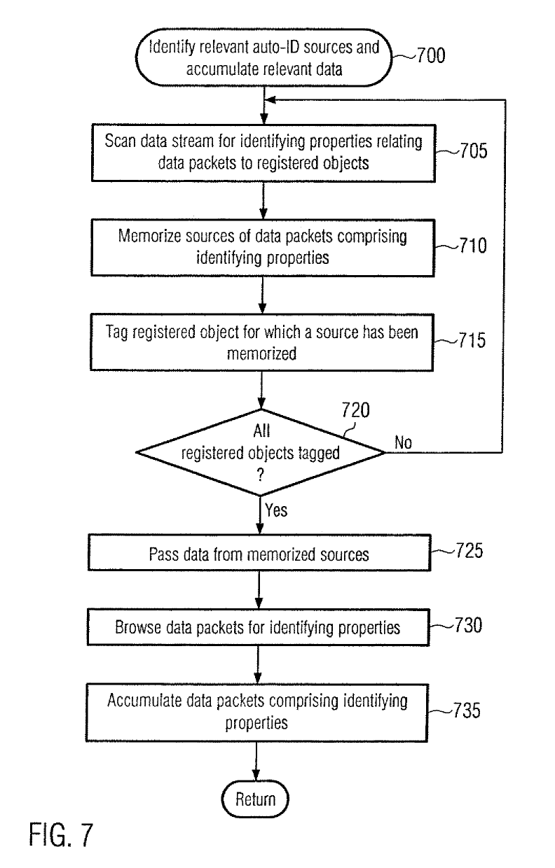

In one embodiment, the corresponding process 700 for identifying relevant auto-ID sources like 302a-302e and/or 360A1-360AN and accumulating relevant data is illustrated in FIG. 7, the data accumulation module 590 may scan at act 705 the incoming data stream or the central repository 550 for objects associated with the previously defined identifying properties. By scanning the data base 550, a record might be found including an identifying property. This record may also comprise the source, namely the auto-ID system, of the respective record. In this case the system 500 may memorize at act 710 the auto-ID system as relevant and tag at act 715 the respective object as “auto-ID system localized”. In one embodiment, the incoming data stream may consist of data packets, wherein each data packet comprises at least one characteristic/property of an object. In that embodiment the data accumulation module 590 may search at act 705 the incoming data packets for identifying properties which relate a data packet to a relevant object. If an identifying property is detected in a data packet, the corresponding object may be tagged at act 715 and the source of the packet may be determined and memorized at act 710.

If it is determined at act 720 that for every registered object an auto-ID source has been found, the data accumulation module 590 may only pass data packets from the memorized sources to the task handling module 570 for further processing of the particular rule at act 725. In those examples, the task handling module 570 must then only process a reduced number of data. At act 730 the task handling module 570 may, for example, browse the data packets for the identifying properties and may accumulate data packets related to registered objects for the rule presently processed at act 735. In one embodiment, the task handling module 570 may hand the characteristics comprised in those packets to the central repository 550 for storing, in other embodiments, the task handling module 570 may immediately proceed with processing the data at act 630 of FIG. 6.

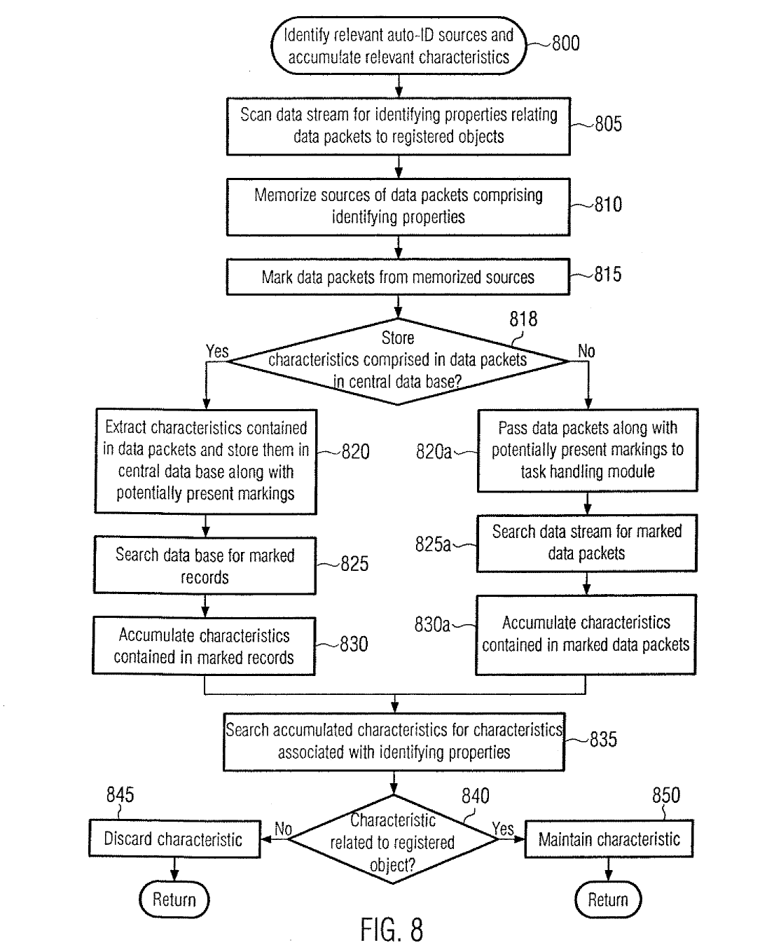

FIG. 8 illustrates another exemplary process 800 for identifying relevant auto-ID systems like 302a-302e and/or 360A1-360AN and accumulating relevant characteristics. In that embodiment, the data accumulation module 590 may scan at act 805 the stream of incoming data packets for identifying properties. In that embodiment the source of every data packet comprising an identifying property may be memorized at act 710. In one example, the data accumulation module may also tag every registered object for which an auto-ID source has been found. In another example, the data accumulation module 590 may analyze every incoming data packet and mark the packet as relevant for a particular rule if the packet comprises an identifying property. In another embodiment, as illustrated in FIG. 8, the data accumulation module 590 may mark at act 815 every packet from a memorized source. The data accumulation module 590 may then pass at act 820 the characteristics along with the potentially annotated markings to the central repository 550 for storing, as illustrated in FIG. 8. If it is determined at act 818 that the characteristics should not be stored (or should not only be stored) in the data base 550 the characteristics may be directly (or in addition) passed to the task handling module 570 along with the markings as a stream of data packets at act 820a. In those embodiments, the characteristics of a particular object can be collected and further processed by the task handling module 570 even if the source of the auto-ID signal changes since the identifying act is continuously repeated for every incoming data packet.

The task handling module 570 may search at act 825, in the exemplary process illustrated in FIG. 8, the data base 550 for records with markings and may accumulate at act 830 the attributes associated with that record. If every record from a memorized source has been marked at act 815, the task handling module 570 may then search the accumulated records for identifying properties at act 835 and maintain at act 850 only characteristics contained in records comprising such identifying properties. If it is determined at act 840 that the characteristics contained in a record are not associated with registered objects, the respective characteristics may be discarded at act 845. If the task handling module 570 receives data directly from the data accumulation module 590 at act 820a, the task handling module will search at act 825a the incoming data stream for markings and may accumulate at act 830a characteristics contained in marked data packets and will proceed as previously described for the search in the data base with act 835. At act 835 the task handling module 570 searches the accumulated characteristics for characteristics associated with identifying properties. If it is determined at act 840 that the characteristic is related to a registered object, the task handling module 570 may maintain the characteristic at act 850 or otherwise discard it at act 845.

Referring back to FIG. 6, the task handling module 570 may check the collected attributes of the relevant objects against the matching condition at act 635 as long as the matching condition is fulfilled or as long as a termination condition is fulfilled. If it is determined at act 640 that the matching condition is fulfilled, the task handling module 570 may issue in some examples a request to the message generator 580 to send at act 645 messages to users registered for that rule. Such messages could be some sort of notification or alert. At act 650 the rule is executed and the action defined in the rule is caused at act 660. The process may start all over if a termination condition is not fulfilled at act 670.

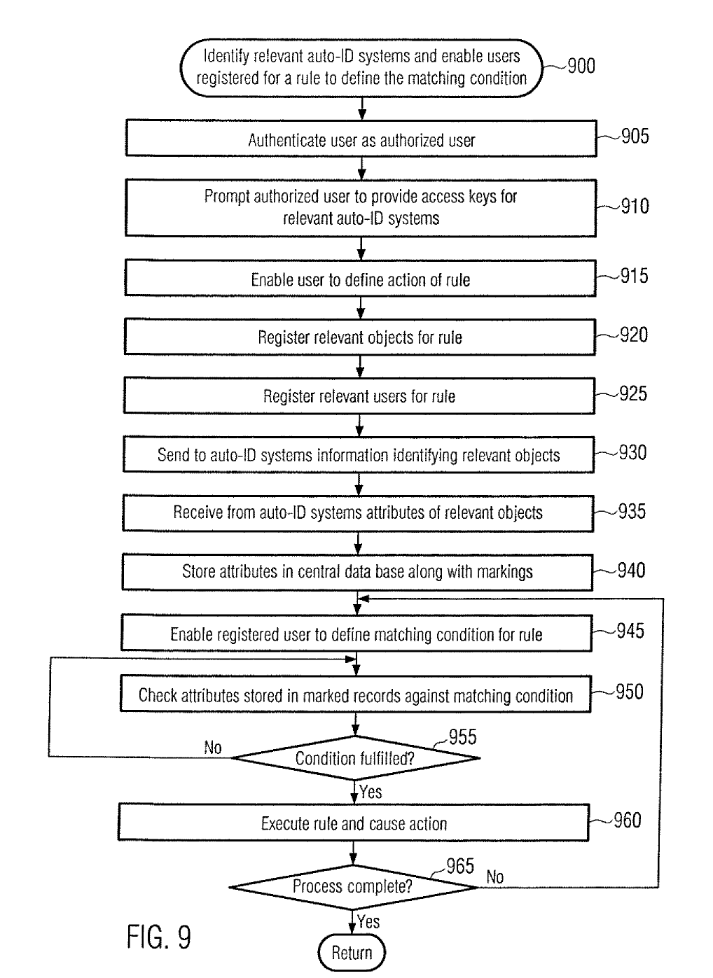

Turning now to FIG. 9, this figure illustrates an alternative process 900 for identifying relevant auto-ID systems like 302 and/or 360A1-360AN. After the system has authenticated a user as authorized at act 905, the task handling module 570 may prompt at act 910 the user to provide access keys and identifiers for relevant auto-ID systems like 302a-302e and/or 360A1-360AN for a rule she/he wants to be processed. After having enabled the user to define an action for the rule at act 915, and after having registered relevant objects (similar to the process illustrated in FIG. 6) for the rule at act 920 and relevant users for the rule (similar to the process illustrated in FIG. 6) at act 925, the task handling module 570 may send at act 930 instructions to the relevant auto-ID systems describing the objects for which characteristics are expected to be collected. The data accumulation module 590 may receive from the identified auto-ID systems attributes of the relevant objects at act 935 and may store them marked in the central data base 550 at act 940 and/or pass them directly to the task handling module 570.

In one example, the user defining the rule has left the matching condition blank in order to enable a user registered for that rule to fill in that condition at act 945. The final acts are similar to the processes previously described. They cause the action at act 960 as defined in the rule if a matching attribute has been found at acts 950 and 955.

The flow of instructions and/or data between the central data processing equipment 201, 250, 301, 351, 500 and the auto-ID systems 302, 360A1-360AN may thus be unidirectional or bidirectional.

In other examples, the user may be asked which identifying process she/he wants to be executed. In some embodiments the authorized user and/or registered users for a particular rule may be in addition enabled to add attributes or characteristics to an object. These attributes/characteristics may also be stored in the central data base 550 and may be marked in some examples as “user added”.

In the following some exemplary embodiments of the invention are described in detail.

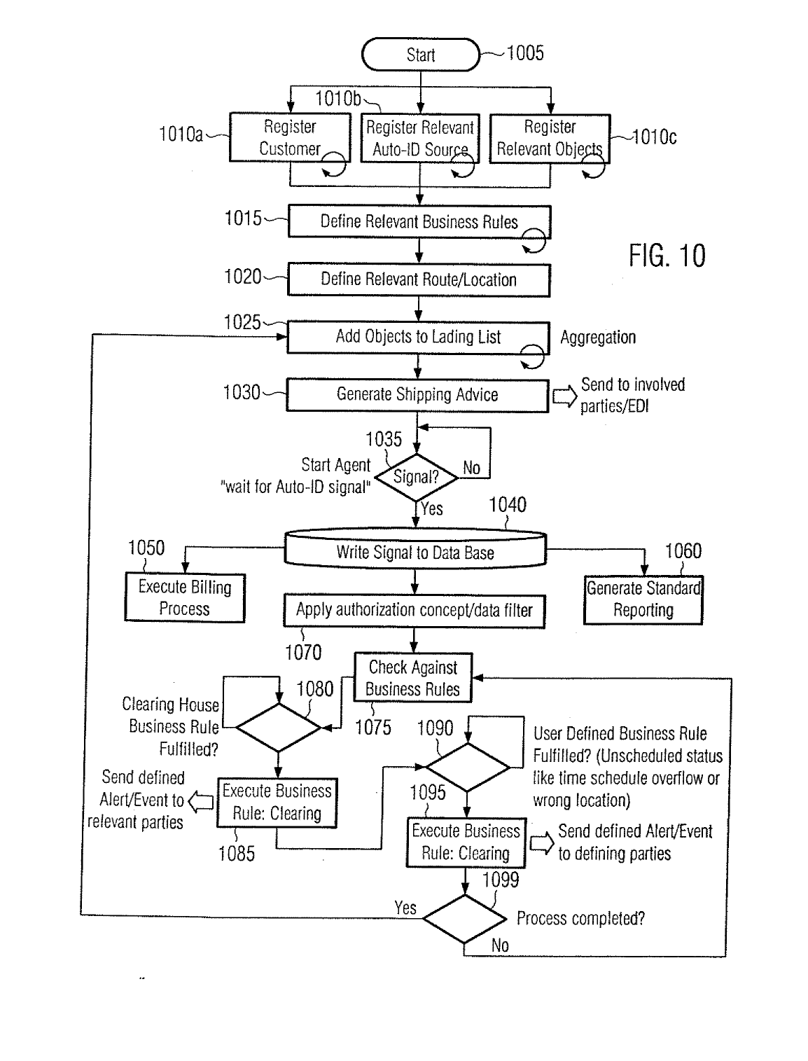

Some embodiments may therefore implement a Clearing House process (see FIG. 10) and clearing system allowing a trusted third party as central entity 201, 250, 301, 351, 500 to receive, map, store, enrich and match signals generated by auto-ID devices or other means of electronic identification against defined business rules. Based on these business rules, defined business events may be automatically processed, whereby full anonymity of the process may be guaranteed by the Clearing House acting as trusted third party.

These Business Events include but are not limited to generation of e.g. (1) real-time alerts if objects are misguided, stolen or subject to changes in temperature or pressure, (2) generation of relevant documents such as advance shipping notice, bill of lading, receiving notice and invoice, other forms of relevant confirmations if objects have undergone defined process steps, (3) regulatory reporting if certain conditions are met (e.g. with regard to pharmaceuticals), (4) ePedigrees documenting the object life cycle including movements, changes in temperature or pressure, (5) automatic payments to settle the cash side of physical transactions if a process step is concluded (delivery vs. payment), (6) real-time response to request by authorized parties with regard to the current geographical location, the point of origination, the authenticity, the physical condition (e.g. pressure, temperature, radiation) and/or the composition (e.g. ingredients of pharmaceuticals, chemical products, dangerous goods), (7) the provision of value added services such as the location based matching of free transport capacity vs. shipping needs. These may be provided by the trusted third party's server system 201, 250, 301, 351, 500 or be distributed in a pervasive manner, such as via the Internet in multiple server locations, as a downloadable client module.

FIG. 10 shows an exemplary auto-ID Clearing House process, which may be established in central data processing equipment like 201, 250, 301, 351, 500.

After starting the process at act 1005, customers may be registered at act 1010a, as well as relevant auto-ID sources (like 302a-302e and/or 360A1-360AN) and relevant objects at acts 1010b and 1010c, respectively. These acts may be performed concurrently or in any desired order. The acts 1010a to 1010c may be performed several times. These acts 1010a to 1010c may correspond to the acts 615 to 625 of the process illustrated in FIG. 6. Similar to the act 610 of FIG. 6, where an authorized user defines a rule, at act 1015 one or more business rules are defined and at act 1020 relevant routes or locations are appointed. The exemplary process of FIG. 10 may illustrate the transaction of objects from a producer via a logistic provider to a retailer. Therefore, objects are added to the lading list at act 1025 as long as the aggregation is completed. At act 1030 a shipping advice is generated and sent to the involved parties. At act 1035 it is determined whether auto-ID signals are received. If such signals are received, the signal is written to the data base 550 at act 1040. This causes, on the one hand, the execution of a billing process defined as a business rule and triggered by the task handling module 570 at act 1050 and, on the other hand, the generation of a standard reporting at act 1060. Furthermore, an authorization concept/data filter is applied at act 1070. Similar to act 635 of FIG. 6, the signals written to the data base are checked against the defined business rules at act 1075 in the task handling module 570. At act 1080, the Clearing House 201, 250, 301, 351, 500 determines whether the Clearing House business rule is fulfilled. If it is determined that the rule is fulfilled, the task handling module 570 will trigger execution of this rule at step 1085 and a defined alert/event is sent to the relevant parties. Further, at act 1090, it is determined whether the user-defined business rule is fulfilled. Such a rule could be for example checking for unscheduled status like time schedule overflow or wrong location. If the business rule is fulfilled, the respective rule is executed at act 1095 and a defined alert/event may be sent to the defining parties.

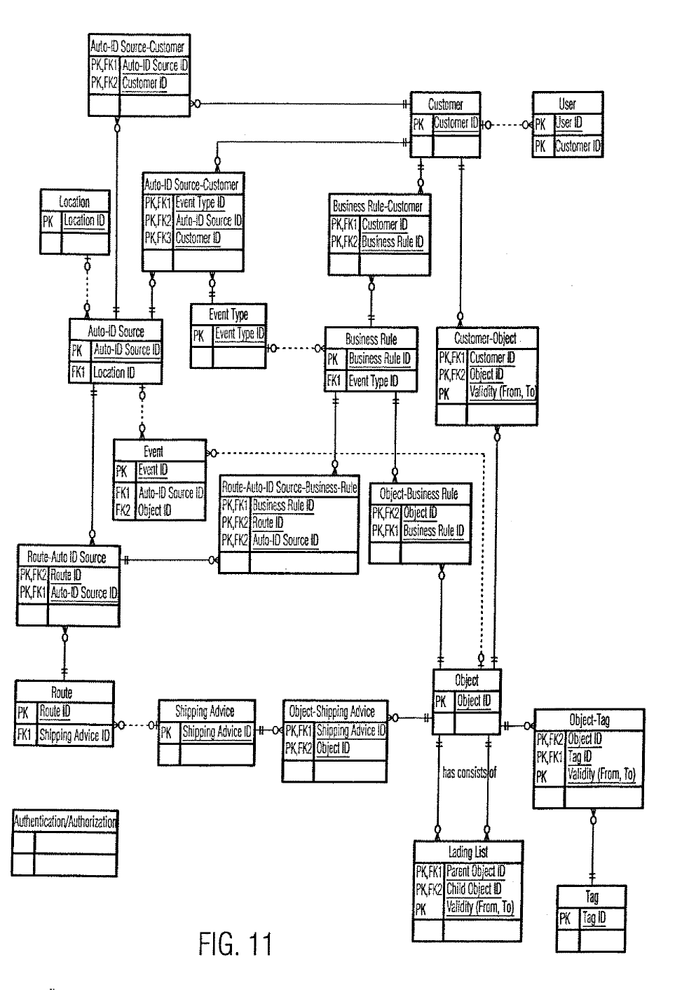

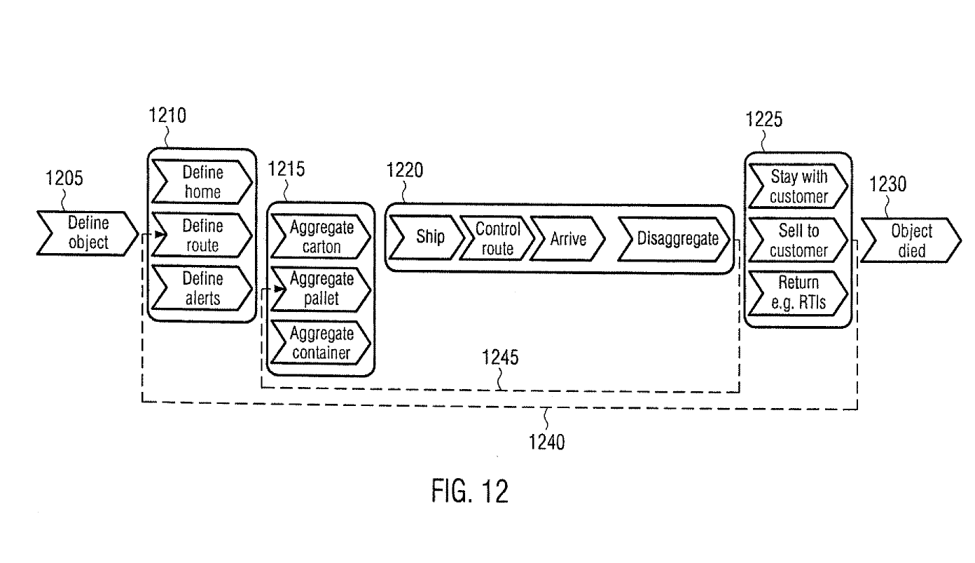

FIG. 11 gives an exemplary entity relationship diagram for a data base scheme which may be used in some embodiments implementing a Clearing House process like that illustrated in FIG. 10. In contrast to other data models in the auto-ID context, the data model of this embodiment reflects all aspects of a generic auto-ID process as illustrated in FIG. 12.

FIG. 12 illustrates an exemplary global object life cycle and supply chain. At 1205, relevant objects are defined. This may be achieved by defining the object type like technical product or system, consumer product or assets (pallets, stands etcetera). Furthermore, activities like start life cycle, attach tag or store data may be defined. At 1210, attributes of the relevant objects are defined. Those attributes may be, but are not limited to, home of asset, owners of the next phases, waypoints and time schedule of the route and alert types and receivers. At step 1215, the aggregation of the objects take place. This aggregation may be surveyed with auto-ID technologies 302, 360A1-360AN and may include items in cartons, cartons on pallets, pallets in containers, and also parts into gears or systems. At act 1220 the logistical routes are surveyed with auto-ID technologies 302, 360A1-360AN. For example, waypoints or time schedules may be checked and events generated by auto-ID equipments may be processed. Also, specific events generated by business messages (e.g. via EDI (Electronic Data Interchange)) like advanced shipping notices and electronic invoices may be executed. The objects may be monitored by the auto-ID systems even after reaching their destinations at 1225. Eventually, the objects die at 1230. The lines 1240 and 1245 indicate special route structures.

The line 1240 may indicate repeating routes of Returnable Transport Items (RGI). The line 1245 may indicate cross docking with repeated disaggregation aggregation cycles.

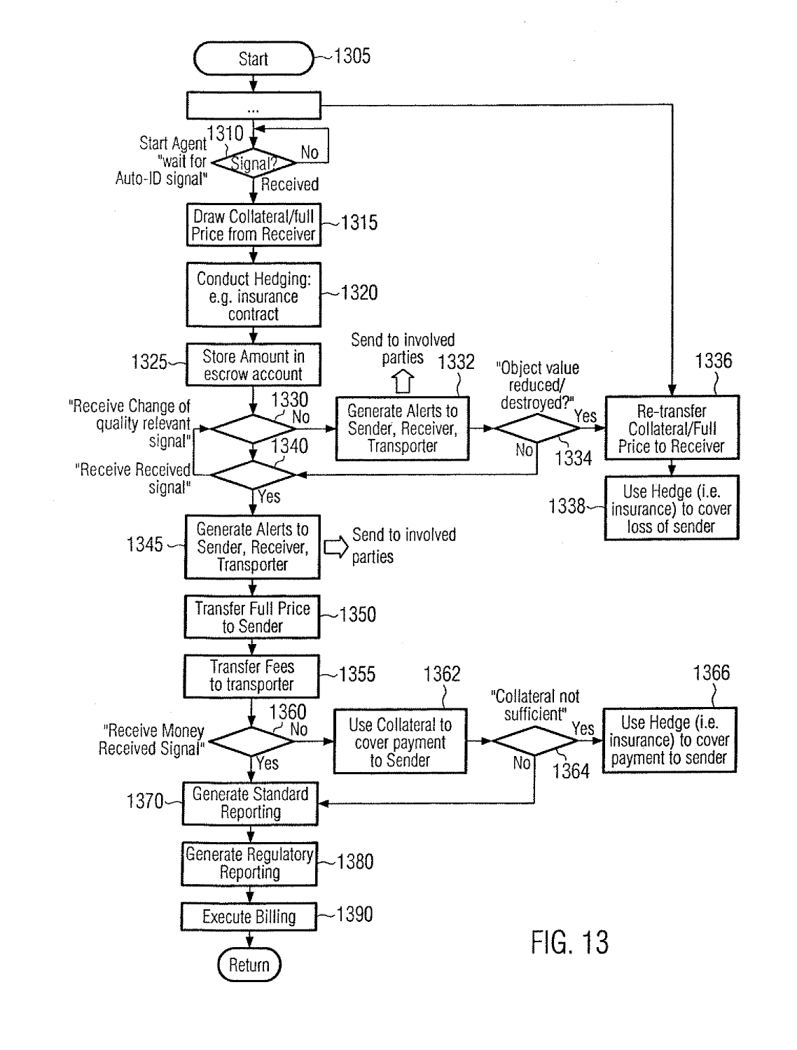

Referring back to FIG. 11, the main use case may be controlling of auto-ID events against business rules either defined by the Clearing House itself or the owner of the respective object. In case of tracking/tracing objects on their shipping routes the business rules and related alerts may focus on objects and their respective shipping advises within predefined timeframes. For the asset management the focus of may be similar, however the alerts might also restrict the asset to a geographical location. In the case of maintenance control, e.g. checking objects with a mobile reader in regular intervals, the business rules will focus on defining a route or time intervals within which a maintenance associated auto-ID event has to occur per object. With regard to ePedigrees the storing of auto-ID data and the provision of data base snapshots at a certain point of time based on an interactive request may be the main objective. Embodiments of the current invention may allow all parties to participate in the Clearing process as illustrated in FIG. 10 with limited local technology investments, while sharing relevant information with others on an anonymous basis and providing straight through processing capabilities. In addition, the central storage and sharing of data may allow new forms of risk management both for the parties involved in the transactions and regulators/state authorities as illustrated in the exemplary process of FIG. 13.

FIG. 13 illustrates an exemplary auto-ID clearing and risk management process, which may be implemented in central data processing equipment like 201, 250, 301, 351, 500. At act 1310 it is determined whether an auto-ID signal is received. If such a signal is received, a collateral/full price is drawn from a receiver at act 1315. At act 1320, hedging, like making an insurance contract, is conducted. The amount is then stored at act 1325 in an escrow account. At act 1330, it is determined whether the received auto-ID signals indicate a change of quality. If this signal is received, the system 200, 250, 301, 351, 500 generates at act 1332 an alert to the sender, the receiver and the transporter of the objects. At act 1334, it is determined whether the object value has been reduced or the object has been destroyed. In the case of a reduced value or even destruction, the collateral/full price is returned to the receiver at act 1336 and the hedge is used to cover the loss of the sender at act 1338. If the object is not destroyed and the value is not reduced, it is determined at step 1340 whether the object has been received by the receiver. If it is determined that the object has reached its destination, alerts are generated at act 1345 to the sender, the receiver and the transporter of the object. At act 1350 the full price is transferred to the sender and the fees are transferred to the transporter at act 1355. At act 1360 it is determined whether the money has been transferred. If the money has not been transferred, the collateral price is used to cover the payment to the sender at act 1362. If it is determined at act 1364 that the collateral is not sufficient, the hedge is used at act 1366 to cover payment to the sender. If, on the other hand, it is determined at act 1360 that the money has been received by the respective users, standard reportings are generated at act 1370 and regulatory reportings are generated at act 1380. Eventually, the billing is executed at act 1390.

Thus, embodiments of the current invention may provide an efficient method and means of processing data resulting from auto-ID processes, independent of the underlying economical/business transaction via the trusted third party acting as central entity 201, 250, 301, 351, 500 ensuring data access security, managing different risk components of the transaction and ensuring a delivery versus payment financial settlement process.

The trusted third party infrastructure 201, 250, 301, 351, 500 in addition may provide an audit trail for all information received and processed. Thereby it may be enabled to provide regulatory reporting for all parties involved with regard to any object and the relevant auto-ID data. In addition the Clearing House can ensure the matching of information originating from different sources and the confirmation of the matching to the relevant parties, the decomposition and management of risk associated with a business transaction, the final financial settlement of the relevant transactions and be used as basis for a secondary market for any kind of object like illustrated in the exemplary process of FIG. 12. Therefore delivery versus payment as well as the deposition of collateral in holding accounts in parallel to the execution of the physical transaction with regard to the relevant objects is introduced.

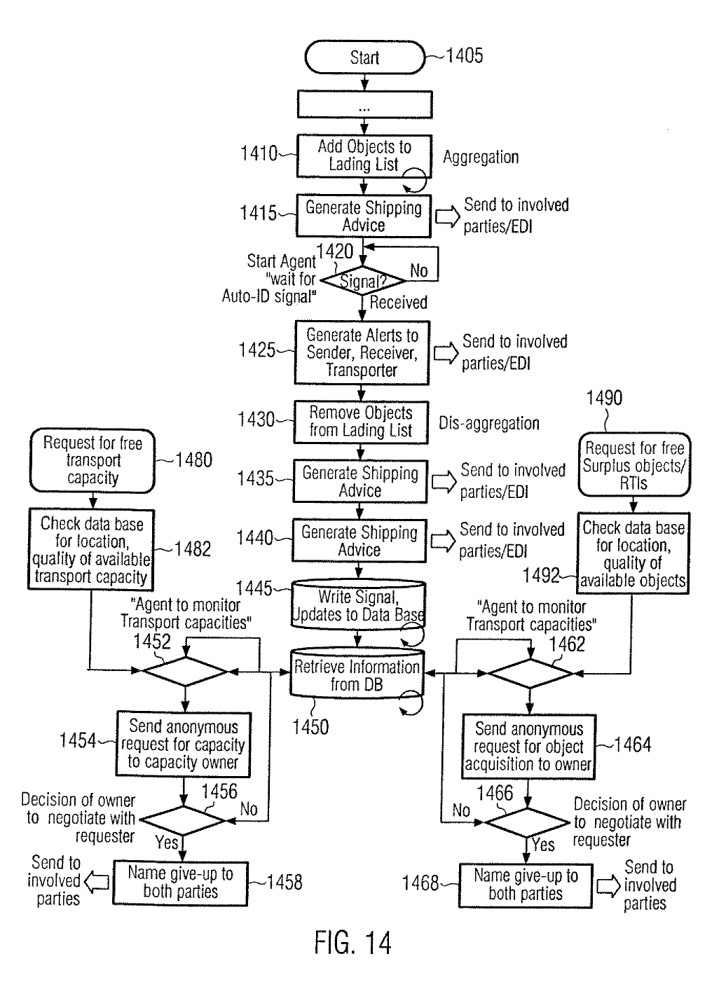

The provided Clearing House mechanism in addition may enable a pre-trade anonymous (secondary) market for transport capacity and objects. The trusted third party electronic 500 may collect auto-ID signals from different sources 302, 360A1-360AN, via different technical infrastructures 310, 370N1-370NN, 510N1-510NN and stores them centrally as previously described. Thereby the Clearing House continuously receives information updates with regard to transport capacities and objects. This includes, but is not limited to, the amount and quality of transport capacity and objects, the respective geographical location, the legal owner and the current owner. Thereby the system may be enabled to process search requests for transport capacities as well as objects and generate matches with available transport capacities and objects, considering their status i.e. geographical location. To ensure full anonymity the system may forward the request for capacity or object in an anonymous form to the legal and/or current owner of the relevant capacity or object, if these parties agreed in general to participate in the market. If the current/legal owner is interested in further negotiating the selling of transport capacity or objects to the requester a name-give-up is conducted. Price and term negotiation could take place outside the Clearing System. The tracking of transport assets and the deposition of objects, including the risk management and cash settlement procedure, will be processed by the system after entered into the standard process by the relevant parties (see process of FIG. 14).

FIG. 14 illustrates an exemplary secondary market process. Similar to the clearing and risk management process illustrated in FIG. 13, objects are added to a lading list at act 1410 and shipping advises are generated at act 1415. As soon as it is determined at act 1420 that auto-ID signals are received, alerts are generated at act 1425 to sender, receiver and transporter. At act 1430, objects are removed from the lading list corresponding to disaggregation. At act 1435, shipping advices are generated and sent to the involved parties. At act 1440, another shipping advice is generated and also sent to the involved parties. The signal updates are written to the data base 550 at act 1445. At act 1450, information is retrieved from the data base 550. At act 1452 (a similar process for free surplus/RTIs is illustrated on the right branch of the flow chart, starting with act 1462) an agent for monitoring transport capacities handles the retrieval of information from the data base 550. For example, a request for free transport capacities may be issued at step 1480, which results in checking the data base 550 for location and quality of available transport capacity at act 1482. This information is also transmitted to the agent for monitoring transport capacities. At act 1452, this information is put together and the agent for monitoring transport capacities sends, at act 1454, an anonymous request for capacity to the capacity owner. At act 1456, the owner of the capacity decides whether she/he wants to negotiate with the requestor. If she/he decides to negotiate, a name give-up is sent to both parties at act 1458.

Returning to the track and trace example given at the beginning, examples of the current invention may allow all interested parties to share information by guaranteeing anonymity and thereby enabling tracking and tracing independent from access to local installations.

Further, today's anti-counterfeiting auto-ID technologies are applied to enable mass serialization, electronic product codes and ePedigrees, Embodiments of the current invention may allow all interested parties to share information by guaranteeing anonymity and thereby enabling auditable reports on the life cycle of objects, even when crossing the borders of individual legal entities, computer systems or other forms of technical infrastructure and standards. In addition, a central source for regulatory reporting to relevant supervisory bodies is created.

Moreover, asset management for the management of moveable asset auto-ID technologies is currently applied to manage objects/assets individually and to link information about location, status and usage automatically with objects. The goal of moveable asset management is to make assets available when needed and ensure their efficient use. It includes activities like locating assets, tracking their usage and ensuring their maintenance. Embodiments of the current invention may therefore allow all interested parties to share information by guaranteeing anonymity and thereby enabling tracking and managing assets independent from local installations.

In general, ePedigrees are a reaction to widespread counterfeiting activities in the area of e.g. pharmaceuticals, highly reliable parts such as plane spare parts and high value products. A pedigree is a certified record that contains information about each distribution of an object, it contains—inter alia—product information, transaction information, distributor information, recipient information and signatures. In an attempt to help ensure only authentic products are distributed through the supply chain, RFID tag based pedigree for individual objects is used. Via the tag, the sale of an object by the producer, any acquisitions and sales by wholesalers or repackagers, and the final sale to a retailer are recorded. The tag stored ePedigree contains product information, transaction information, distributor information, recipient information, and signatures. Embodiments of the current invention may allow all interested parties to centrally access information about objects and the life cycle independent from the RFID tag, thereby regulatory reporting is substantially enhanced. In addition, some examples may allow alerts if noticeable problems in the life cycle occur, i.e. a mismatch between intended addressee and actual receiver.

In addition, for the purposes of vehicle and personal access control, auto-ID technologies, together with intelligent gate controllers, are currently used to enhance the vehicle and personal screening efforts of security at installations gates or access stores to specific internal areas. Embodiments of the current invention make these applications available in open looped environments.

For the purposes of contactless payment, RFID technology is used to identify the person and its payment mode. This might involve RFID cards, e.g. used for mass transit ticketing or RFID tags which are injected under the skin, e.g. in discotheques. Embodiments of the current invention may allow all interested parties to share information gained in such systems and thereby to generate e.g. an aggregated billing to single user.

### CONCLUSION

As may be seen from the above description of the various embodiments, a underlying idea of the current invention is the combination of existing auto-ID technology, features of systems which today process such signals (e.g. ERP systems) and the processes today used in Clearing Houses and secondary markets.

Due to the emerging of auto-ID technologies which allow the automatic identification of physical objects which are equipped with a relevant signaling device, the management of physical objects can be automatized. This technical progress may in the future allow the automated application of many services (i.e. secondary market trading, preferential matching, clearing, risk management, collateralization etc.) currently only available for financial products to physical objects/goods.

Financial markets and Clearing Houses operate on the basis of fungible goods, which are either centrally stored in depositories or delivered at certain delivery points as well as on the basis of the same “quality” of participants in the market with regard to creditworthiness and ability to deliver in time and quality. However, there are substantial differences in the required process and technical infrastructure. By intelligent joining the main features of both worlds and by providing suitable technology and processes, some embodiments provide an end-to-end automatization in the management of physical goods as well as in the related exchange of information and cash flows (Straight Through Processing, STP).

As may further be seen from the above description, various embodiments are based on the finding that Clearing Houses usually allow for pre- and post-transaction anonymity of all involved parties in the trading of financial products and derivatives. Further, the embodiments consider the fact that Clearing Houses usually allow for mitigation of (counter party, market and settlement) risks and thereby ensure the same “quality” of all participants conducting transactions in the system. In addition, the embodiments take into account the capability of Clearing Houses to provide straight through processing of transactions until a financial settlement is achieved.

Moreover, the embodiments of the current invention are based on the finding that auto-ID technologies usually allow for automated identification of objects and relevant attributes, automated determination of the status of objects (e.g. geographical location, pressure, temperature and other environmental conditions), and automated exchange of information based on the auto-ID events between parties involved as far as bilaterally compatible interfaces or joint platforms exist,

Today's systems are closed loop solutions with limited exchange of data via standard interfaces. The data is held in such systems de-centralized and potentially redundant. In addition, only relevant sub-sets of data are exchanged, whereas full data for the life-cycle of an object is potentially not accessible for all involved parties. Moreover, relationships for usage of those systems and the exchange of data are based on bi-lateral or complex multi-lateral contractual relationships. That is, all involved parties have to know and accept all other parties participating in such a prior art system.

In contrast to this, various embodiments of the present invention may allow an exchange of data over boundaries of legal entities as well as individual technical infrastructures and/or a fully automated combination of movement of physical objects with the movement of relevant information and cash flows respectively. In addition, examples of the present invention may substitute a multitude of bi-lateral contractual relationships or more complex contractual relationships between multiple parties by a standard framework agreement between each participating party and the Clearing House 201, 250, 301, 351, 500 (process/cost efficiency). Similarly, embodiments of the present invention may substitute a multitude of bi-lateral technical interface connections or more complex standard interfaces used by multiple systems by a standard connection between each participating party and the Clearing House 201, 250, 301, 351, 500.

As may further be seen from the above description of the various embodiments of the present invention, the mapping or conversion of data between the involved systems is centralized in a Clearing House system 201, 250, 301, 351, 500. Accordingly, data may be held centralized and not redundant by a plurality of involved parties. This may enable both exchange of only relevant sub-sets of data and full data access for all involved parties (in anonymous form if desired) and thereby may improve cost efficiency.

Since all data may be stored centrally, data may be made anonymous and access/authorization concepts may manage what parties can access what information. Thereby all data may be available centrally. This allows e.g. for a non-anonymous regulatory reporting over the full lifecycle of a physical object from a central source as well as for an anonymous statistical reporting to all involved parties, allowing them to optimize their processes.

As the full life-cycle including all relevant movements and ownership changes may be documented in some embodiments centrally, the underlying cash settlement for such transactions may also be handled centrally. Given the technology to monitor the environmental conditions and geographical location of objects even the risk of quality reduction or loss of objects may be managed.

Given the standard contractual framework, a working cash settlement infrastructure as well as collateral and escrow accounts allowing for delivery vs. payment, transactions may be fully made anonymous as the quality of each party towards all other parties is equal. This may allow for the implementation of a secondary market for goods as well as for transporting capacities.

Moreover, embodiments of the present invention may reduce for all participating parties transaction risk with regard to quality of objects as well as cash settlement of transactions with known and un-known counterparties. In addition, the IT spending for building, operating and maintaining interfaces or whole own technical systems may be substantially reduced as well as the IT spending for supporting many different standards for the exchange of information due to the central conversion and mapping of information. Finally, overhead resulting from negotiating and maintaining multiple contractual relationships may substantially be reduced.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar have not been described herein in order to not unnecessarily obscure the invention described herein. Accordingly, it is to be understood that the invention is not to be limited by the specific illustrative embodiments, but only by the scope of the appended claims.

TABLE 1

| | | Record | Attribute | Attribute | Attribute | Attribute | Attribute | Attribute | Attribute | Attribute |
|---|---|---|---|---|---|---|---|---|---|---|
| Owner | | access | 1 | 1 access | 2 | 2 access | 3 | 3 access | 4 | 4 access |
| A | Record | public | Value | | Value | | Value | | Value | |
| | 1 | | 11 | | 12 | | 13 | | 14 | |
| A | Record | restricted | Value | none | Value | B | Value | B | Value | public |
| | 2 | | 21 | | 22 | | 23 | | 24 | |
| B | Record | none | Value | | Value | | Value | | Value | |
| | 3 | | 31 | | 32 | | 33 | | 34 | |
| C | Record | A | Value | | Value | | Value | | Value | |
| | 4 | | 41 | | 42 | | 43 | | 44 | |
| D | Record | B, C | Value | | Value | | Value | | Value | |
| | 5 | | 51 | | 52 | | 53 | | 54 | |
| D | Record | public | Value | | Value | | Value | | Value | |
| | 6 | | 61 | | 62 | | 63 | | 64 | |
| D | Record | public | Value | | Value | | Value | | Value | |
| | 7 | | 71 | | 72 | | 73 | | 74 | |

1. A physical objects tracking system comprising: at least one short range communication network configured to collect data identifying physical objects and attributes associated with said objects; and at least one long range communication network comprising: central data processing equipment hosted by a trusted third party, said central data processing equipment being configured to aggregate and store data collected by the short range communication network; and at least one user terminal configured to enable an authorized user to access the data processing equipment hosted by the trusted third party to evaluate the aggregated and stored data.

2. The system as recited in claim 1 wherein said at least one short range communication network comprises a short range communication network having at least one reader and a plurality of tags, each tag being assigned to one object and comprising the data identifying said one object and attributes associated with said object and the reader being configured to read out the data stored on the tags.

3. The system as recited in claim 2 wherein the at least one reader comprises a GPS (Global Positioning System) receiver.

4. The system as recited in claim 2 wherein at least some of said plurality of tags comprise a GPS receiver, and the at least one reader is further configured to read out the GPS receiver.

5. The system as recited in claim 2 wherein at least some of said plurality of tags comprise a sensor configured to measure physical properties of the object to which the sensor is assigned to or of the environment in which the object is located and wherein the at least one reader is further configured to read out the sensor.

6. The system as recited in claim 5 wherein the sensor is configured to measure one or more of a current temperature of the object, a current temperature inside the object, a current temperature of the environment in which the object is located, a barometric pressure of the environment in which the object is located, a pressure inside the object, a humidity of the environment in which the object is located, a humidity inside the object, an oxygen concentration of the environment in which the object is located, an oxygen concentration inside the object, an hydrogen concentration of the environment in which the object is located, an hydrogen concentration inside the object, an acceleration of the object, a radioactivity of the environment in which the object is located and a radioactivity inside the object.

7. The system as recited in claim 5 wherein at least some of the plurality of tags further comprise one or more of a motion detector, a camera or a microphone and wherein the at least one reader is further configured to read out one or more of said motion detector, said camera or said microphone.

8. The system as recited in claim 2 wherein the at least one reader further comprises one or more of a motion detector, a camera or a microphone.

9. The system as recited in claim 8 wherein the at least one reader comprises a sensor configured to measure physical properties of the environment in which the at least one reader is located.

10. The system as recited in claim 9 wherein the sensor is configured to measure one or more of a current temperature, a barometric pressure, a humidity, an oxygen concentration, an hydrogen concentration and a radioactivity of the environment in which the at least one reader is located.

11. The system as recited in claim 2 wherein the at least one reader is stationary.

12. The system as recited in claim 2 wherein the at least one reader is portable.

13. The system as recited in claim 2 wherein the at least one reader is an RFID (Radio Frequency ID) reader and the tags are RFID tags.

14. The system as recited in claim 2 wherein the at least one reader is a bar code scanner and the tags comprise bar codes.

15. The system as recited in claim 1 wherein the central data processing equipment is further configured to match the aggregated data against pre-defined conditions.

16. The system as recited in claim 15 wherein said pre-defined conditions have been previously defined by said authorized user.

17. The system as recited in claim 15 wherein the central data processing equipment is further configured to execute a business rule, wherein the business rule is executed if said pre-defined conditions are fulfilled and wherein the business rule causes a business event.

18. The system as recited in claim 17 wherein said business rule has been previously defined by said authorized user.

19. The system as recited in claim 18 wherein the business event is one of billing, executing a payment, drawing cash to an escrow account, booking cargo capacity or physically transacting objects.

20. The system as recited in claim 1 wherein the at least one long range communication system comprises one of the Internet, POTS (Plain Old Telephone Service), ISDN (Integrated Services Digital Network), SONET (Synchronous Optical Network), ATM (Asynchronous Transfer Mode) network, GSM (Global System for Mobile Communication), GPRS (General Packet Radio Service), UMTS (Universal Mobile Telecommunication System), HSDPA (High Speed Downlink Packet Access), CDMA2000 (Code Division Multiple Access) or WiMAX (Worldwide Interoperability for Microwave Access).
